(19) United States
(12) Patent Application Publication
(10) Pub. No.: US 2025/0243372 A1
(43) Pub. Date: Jul. 31, 2025

(54) GAS BARRIER LAYER, NANOCOMPOSITE LACQUER FOR PRODUCING THE GAS BARRIER LAYER AND PROCESS FOR PRODUCING THE LACQUER

(71) Applicant: Fraunhofer-Gesellschaft zur Förderung der angewandten Forschung e.V., München (DE)

(72) Inventors: Peter EISNER, Freising (DE); Stefan SCHIESSL, Freising (DE); Esra KÜCÜKPINAR-NIARCHOS, Freising (DE)

(73) Assignee: Fraunhofer-Gesellschaft zur Förderung der angewandten Forschung e.V., München (DE)

(21) Appl. No.: 18/704,179

(22) PCT Filed: Oct. 14, 2022
(86) PCT No.: PCT/EP2022/078653

§ 371 Date: Apr. 24, 2024

(30) Foreign Application Priority Data
Oct. 25, 2021 (DE) 10 2021 127 635.7

(51) Int. Cl. C09D 7/61; C08K 7/00; C09D 7/40; C09D 7/80; C09D 123/08; C09D 129/04

(52) U.S. Cl. CPC C09D 7/61; C09D 7/70; C09D 7/80; C09D 123/0846; C09D 129/04; C08K 7/00; C08K 2201/004; C08K 2201/011

(57) ABSTRACT

The present invention relates to a gas barrier layer, to a nanocomposite lacquer suitable for producing the gas barrier layer and to a process for the production thereof. The gas barrier layer consists of a polymeric material into which platelet-shaped nanoparticles are embedded, wherein the nanoparticles are silicates, in particular phyllosilicates. The nanoparticles in the polymeric material have a homogeneous size distribution such as is obtained in an exfoliation of montmorillonites as nanoparticles at a rotational speed of 400 rpm for more than 30 minutes in a ball mill operated with a zirconium dioxide container and zirconium dioxide balls having a ball diameter of less than 50 mm. The proposed gas barrier layer is highly functional, is cost-effective to produce, ensures durable barrier properties on flexible films and moving components and is simple to apply and to dry.

### TECHNICAL APPLICATION FIELD

The present invention relates to a gas barrier layer of a polymeric material, in which platelet-shaped nanoparticles are embedded. The invention also relates to a nanocomposite lacquer for producing the gas barrier layer, and a process for producing the nanocomposite lacquer.

In the context of this patent application, the term nanoparticle is understood to mean a particle that extends less than 100 nm in at least one dimension. The dimension with the smallest extension is referred to as the thickness, the other two dimensions are referred to as the length and the width. In this patent application the term lacquer implies that it refers to the liquid and ready-to-coat nanocomposite. The (gas) barrier layer is defined in this patent application as the cured nanocomposite lacquer which has a specific dry layer thickness and contains the polymer and nanoparticle components.

The nanocomposite lacquer serves to create or increase the gas barrier of flexible surfaces, such as films or paper, or on solid three-dimensional, oscillating or vibrating surfaces that are deformed elastically or plastically for example by (dynamic) application of mechanical force. These include for example containers made from various materials that are subject to fluctuating pressure, or oscillating, vibrating components or components that are alternatingly stressed and relaxed, such as container walls, pipelines, valves or seals, consisting of materials that are to some degree readily permeable by gases. These permeable materials may be plastics, metals, ceramics, natural substances or composites and are provided with the barrier layer to enable a barrier effect against water vapour, hydrogen, helium, oxygen or other gases. Another application field that is also feasible for the nanocomposite lacquer is the coating of materials in furniture making, in order to reduce outgassing of formaldehyde or other solvents.

### PRIOR ART

Gas barriers are needed in many technical applications. They are used when it is important to ensure that a gas does not diffuse through a material (plastic, metal, natural substance), or only to a very limited degree, in order to either store an enclosed gas with minimal loss, or to protect enclosed contents (e.g., food) from the ingress of gas. If the intrinsic gas barrier of the material used is not sufficient to fulfil the requirement governing the barrier, the barrier may be produced in an enhancement step, usually by vaporising or by the application of coating layers, or an existing barrier may be improved. In this case, the expression “barrier” describes the resistance of the materials to permeation by the gas. The permeation rate is defined as the volume of gas that permeates through a specified area per unit of time under a specified pressure differential. The smaller this permeating gas volume is, the better the barrier is.

The enhancement step for the application of a barrier is necessary because the substrate material is chosen predominantly on the basis of its mechanical, haptic and/or optical properties, and often forms a very poor barrier, or none at all (for example paper, natural films, plastics, etc.). A few enhancement steps for the application of a gas barrier are known according to the prior art. In the case of vaporisation, for example, a layer of metal oxide or silicon oxide is deposited by means of a physical vapour deposition. These processes are mainly used to produce strong barriers to oxygen and water vapour. However, there are some disadvantages associated with vaporisation. For example, the plants for vapour deposition are very expensive, the amount of energy needed to implement a vapour deposition process is also relatively high. In particular, the creation of a vacuum consumes a lot of time and energy. In some systems, which contain a great deal of moisture, for example paper webs, it is also very difficult if not impossible to maintain a stable vacuum without very high energy expenditure. A further disadvantage is that vaporisation with aluminium, for example, results in an opaque surface, which in many cases is undesirable. Moreover, high-quality vapour deposition can only be achieved on very flat surfaces, so for many substrate materials a planarisation step must be carried out, which in turn increases the costs.

The application of barrier lacquers represents a second option for improving the barrier. According to the prior art, there are solvent-based barrier lacquers (for example PVDC systems), which may be the source of a health hazard, and which therefore necessitate the use of an extraction system during processing. These solvent-based systems are becoming less and less popular in the foodstuffs and other industries. Other single-phase barrier lacquers without nanoparticles that are available according to the prior art only yield a corresponding barrier if the coating is thick enough, which in turn drives up the costs for materials and drying.

The international patent application WO 2016087578 A1 describes the coating of a substrate with two layers of different composition arranged one on top of the other to produce a gas barrier. The first composition comprises an alcohol-based binder and an inorganic particulate material. The second composition comprises a latex binder and a phyllosilicate. Polyvinyl alcohol may be cited as one example of the alcohol-based binder, and a flaked phyllosilicate as an example of the inorganic particulate material. The phyllosilicate is reduced beforehand in one or more comminution steps, in particular by milling. Beads or granulate made from a plastic (e.g., nylon), sand or ceramic grinding or milling additive may be used for the comminution.

US2018215896 A1 discloses a transparent, self-assembling, highly ordered polymer-nanocomposite coating on a substrate. The polymer-nanocomposite coating comprises a water-dispersible polymer with side groups on the backbone, which may be polar or ionic. The polymer-nanocomposite coating further includes platelet-shaped nanoparticles with a large aspect ratio, which may have small ions or molecules on their surface. Polyvinyl alcohol (PVOH) for example is used as the water-dispersible polymer, smectite clay such as montmorillonite (MMT) as the platelet-shaped nanoparticles. The platelet-shaped nanoparticles are contained in the coating composition in a concentration from 0.1%-0.5% by weight, preferably 0.15-0.45% by weight. The lacquer formed thereby is applied by inkjet printer, spraying or dipping. The document provides no further details about how the platelet-shaped nanoparticles are obtained from the starting material.

The object of the present invention consists in describing a gas barrier layer, a nanocomposite lacquer suitable for producing the gas barrier layer and a process for the production thereof which enable the production of a highly functional and cost-effective gas barrier, also as a single layer, that ensures durable barrier properties on flexible films and moving components, can be transparent in design, and is simple to apply and to dry. The gas barrier layer should have a good barrier effect even against smaller gas molecules such as helium or hydrogen.

### SUMMARY OF THE INVENTION

The object is solved with the gas barrier layer according to claim 1, the nanocomposite lacquer according to claim 9 and the production process according to claim 17. Advantageous variants of the gas barrier layer, the nanocomposite lacquer for generation thereof, and of the process for production are the object of the dependent claims or may be discerned from the following description and exemplary embodiments.

The gas barrier layer according to the invention consists of a polymeric material, in which platelet-shaped nanoparticles are embedded. The nanoparticles are silicates, in particular phyllosilicates, and have a size distribution in the polymeric material which is at least as homogeneous as that obtained in an exfoliation of montmorillonites as nanoparticles in a ball mill (PULVERISETTE 6 by company Fritsch) at a rotational speed of 400 rpm for more than 30 minutes, operated with a zirconium dioxide container and zirconium dioxide balls, having a ball diameter of less than 50 mm. The homogeneous size distribution of the nanoparticles in the gas barrier layer according to the invention may thus be verified by comparing it with the homogeneity of the size distribution in a gas barrier layer in which the nanoparticles are montmorillonites that have been exfoliated under the conditions stated above and dispersed in the polymeric material correspondingly. The size distribution in the gas barrier layer according to the invention has at least such homogeneity. With this homogeneous size distribution of the nanoparticles, the gas barrier layer has a permeation rate for helium which is less than 250 cm³. (STP) 1 μm/(m²·d·bar). The permeation rate for oxygen is from 0.05 to 0.2 cm³ (STP). 1 μm/(m²·d·bar) per μm layer thickness.

The suggested nanocomposite lacquer for generating the gas barrier layer is formed by a mixture of a polymeric binder, preferably a water-soluble polymeric binder, and platelet-shaped nanoparticles which have been dispersed in the binder. The nanocomposite lacquer is characterized in that the nanoparticles are silicates, in particular phyllosilicates, which have a size distribution in the binder which is at least as homogeneous as that obtained in an exfoliation of montmorillonites as nanoparticles in a ball mill (PULVERISETTE 6 by company Fritsch) at a rotational speed of 400 rpm for more than 30 minutes, operated with a zirconium dioxide container and zirconium dioxide balls, having a ball diameter of less than 50 mm. This homogeneous size distribution is characterized by a low fraction of nanoparticle agglomerates in the nanocomposite lacquer as well as in the barrier layer, that is to say in the cured nanocomposite lacquer. The agglomerates are relatively large particles, which are detectable in the lacquer and the barrier layer using the various methods described hereafter. In this context, a low fraction is understood to refer to the proportions relating to the detection methods in the following. FIG. 4 shows an example of such a homogeneous size distribution of the nanoparticles in the lacquer according to the invention, such as may be obtained by comminuting the particles with a ball mill, compared with a lacquer (comparison lacquer) that does not have such a homogeneous distribution of the nanoparticles. The figure clearly shows a further maximum of the distribution with a larger particle radius in the comparison lacquer, while the lacquer according to the invention has a substantially more homogeneous distribution with just one maximum.

The fraction of agglomerates in the barrier layer is detectable by examining a cut of the cross-section of the barrier layer under a scanning electron microscope. For this purpose, a special sample preparation process should be carried out, which is known to the person skilled in the art. It consists of cutting the barrier layer, preferably as a free standing film or—if possible—as a coating on a sufficiently thin substrate (<1.5 mm), and polishing the cut surface with an ionised gas beam by means of a cross-section polisher. The polished cross-section is examined under the scanning electron microscope, and the surfaces that can be assigned to larger silicate particles with cut surface>0.01 μm are determined graphically. The sum of these cut surfaces of the agglomerates or larger silicate particles is incorporated in the percentage of the total area of the barrier layer cross-section. With the described homogeneous size distribution of the barrier layer according to the invention, the sum of the cut surfaces>0.01 μm of silicate particles relative to the total area of the cross-section of the barrier is less than 10%, advantageously less than 5%, particularly advantageously less than 3% or 1%. An example of the different cut surfaces in corresponding micrographs in a measurement of the proposed gas barrier layer compared with a gas barrier layer (comparison layer) that does not have such a homogeneous distribution of the nanoparticles, is evident from FIG. 3. In this context, FIG. 3A is a schematic representation of the cut surfaces of silicate particles with a cut surface>0.01 μm² in the comparison layer, FIG. 3B represents these cut surfaces in an exemplary embodiment of the gas barrier layer according to the invention.

The fraction of agglomerates in the lacquer may be determined using the known technique of laser diffraction. In the indicated homogeneous size distribution of the nanoparticles in the nanocomposite lacquer, in a particle size distribution determined using laser diffraction a fraction of particles with an extension of >1 μm in at least one dimension is less than 10%.

This homogeneous size distribution represents an essential feature of the proposed gas barrier layer, and also of the nanocomposite lacquer used for production thereof, since it requires a special comminution of the silicate particles that are present as agglomerates, as is achieved with the proposed production process. Through this homogeneous distribution of the nanoparticles used, in conjunction with the binder used a gas barrier that is also effective with regard to smaller gas molecules, such as helium, is obtained even with thin layers of the applied and dried nanocomposite lacquer, for example with a coating thickness of 1-20 μm.

Due to the homogeneous size distribution of the nanoparticles dispersed in the suggested nanocomposite lacquer, said coating has a brightness L*, determined according to CIE-L*a*b* colorimetry, greater than 80, preferably greater than 85, particularly preferably greater than 90. This brightness is created due to the homogeneous size distribution without or with only a very small fraction of agglomerates.

An ingredient used for preference as a polymeric binder is polyvinyl alcohol with an ethylene content between 1 and 40%, preferably between 6 and 10% by mass, wherein use of an acrylate, a polyurethane solution or a polyvinylidene chloride solution (PVDC) is also advantageous. Montmorillonites are particularly advantageously used as nanoparticles. The platelet-shaped nanoparticles preferably have a thickness in the range from 10 to 30 nm and a surface length in the range from 150 to 500 nm. In this context, the term surface length is understood to mean the largest extension perpendicular to the thickness direction of the platelet or particle. The thickness direction corresponds to the direction of smallest extension.

The nanoparticles preferably constitute a fraction from 10 to 80% by mass, better from 25 to 60% by mass, particularly advantageously about 50% by mass of the total solid content of the gas barrier layer and the nanocomposite lacquer. In principle, a fraction of the nanoparticles in the total solid content between 5% by mass and up to 90% by mass is possible. The term total solid content is understood to mean the sum of nanoparticles and polymer in the binder and polymeric material. In the lacquer, this total solid content, also referred to as solid content of the lacquer in the following text, may be varied from 0.5 to 20% by mass. Advantageously, there is a total solid content of 3 to 8% by mass, particularly advantageously about 6% by mass in the lacquer. The solid content determines the viscosity of the lacquer, which is decisive for the application behaviour, among other things.

In order to apply the lacquer to a substrate, for example a polymer film, usual lacquer application methods may be used. The lacquer is spread evenly over the surface to be coated, and after the application it is dried to vaporise or evaporate the water (or solvent). In the process, the lacquer solidifies progressively.

The gas barrier according to the invention thus consists of one fraction of platelet-shaped silicate nanoparticles and polymeric and preferably water-soluble binder, such as for example polyvinyl alcohol (with an ethylene content) or another, which surrounds the nanoparticles in the form of a matrix. Other binders may be for example acrylate dispersions, PVDC solutions, polyurethane solutions or others.

In this context, the drying is carried out in such manner that the evaporation rate is between 5 and 100 g/m² per minute, advantageously between 10 and 50 g/m² per minute. The applied lacquer layer is particularly advantageously dried at a temperature of 80° C. with an evaporation rate of about 30 g/m² per minute. In general, the possible drying temperature is mostly determined by the substrate. For the nanocomposite lacquer, drying temperatures from room temperature up to 140° C. are possible.

Drying preferably continues until the water content in the dried lacquer layer, that is to say in the gas barrier layer according to the invention, reaches 0.3-10% by mass, advantageously between 0.5 and 5% by mass, particularly advantageously between 0.6 and 1% by mass. The values for the water content refer to a determination with the Karl Fischer method. In the case of polyvinyl alcohol with an ethylene or ethylene vinyl alcohol (EVOH) content as binder, an interaction takes place between the silicate particles and the EVOH the form of hydrogen bridge bonds. In this context the terminal hydroxide groups of an EVOH chain interact with the terminal oxygen atoms in the silicon tetrahedra of the silicates. This interaction can be detected with a FTIR measurement, wherein the “stretching mode” of the carbon-oxygen bond shifts from 1092 cm−1 to shorter wave numbers and the stretching mode of the silicon-oxygen bond shifts from 1026 cm−1 to higher wave numbers.

The drying results in a thin, solid layer with embedded nanoparticles, which has a certain degree of flexibility depending on the deposition and arrangement of the particles, and thus sustains a very good gas barrier even on flexible films, vibrating components as well as on surfaces of systems or receptacles that are exposed to pressure fluctuations, also for components that are mechanically stressed in this way. The lacquer layer is particularly advantageously applied in such as way that a certain proportion of the particles in the dried layer are aligned flat, wherein less than 50%, better less than 25%, particularly advantageously less than 10% of the mass of the particles manifest an orientation of greater than 70° (angle α), less than 60%, better less than 30%, particularly advantageously less than 15% of the mass of the particles manifest an orientation of greater than 60° (angle α), particularly advantageously less than 25% of the mass of the particles manifest an orientation of greater than 45° (angle α). The angle α and the alignment of the particles 1 in the dried layer 2 on the substrate 3 are suggested schematically in FIG. 1. In a particularly advantageous embodiment of the gas barrier produced according to the invention, more than 95% of the mass of the particles are aligned at an angle from −30 to +30° or better at an angle from −20 to +20° with respect to the surface of the substrate.

The gas barrier layer, i.e. the layer of the nanocomposite lacquer that is applied to and dried on the substrate, preferably has a thickness from 0.2-1000 μm auf, more preferably 1-20 μm, particularly advantageously 1-3 μm. The optical appearance after application is transparent to milky depending on layer thickness and roughness, and depending on the nanoparticles used may be coloured from whitish (in the base of montmorillonites for example) to slightly brownish. Other shades of colour are also possible. If lamination with a sealing film is carried out subsequently, in some cases a contact transparency also develops.

It has been found that the gas barrier layer according to the invention makes it possible to apply a barrier, even to films with high gas permeability for food packaging, that is so effective against oxygen or water vapour that greases and oil are not oxidised for weeks and much longer and in foods the original properties (the crunchiness of crisps for example) are preserved for long periods.

But surprisingly, it has also been found that it is not only the permeation of oxygen through films which is slowed significantly by the gas barrier layer according to the invention, but because of the homogeneous size distribution of the nanoparticles the gas barrier also forms a highly effective barrier to much smaller gas molecules, and even in the case of gases such as helium or hydrogen reduces the mass transfer to less than 250, advantageously less than 100, particularly advantageously less than 50 cm³·μm/m²·d·bar. Accordingly, it is possible to provide films, containers, tanks or pipelines with an extremely effective hydrogen or helium barrier simply by applying coatings to the interior and/or exterior surfaces thereof.

Unlike a system for gas phase deposition, the expense associated with the production of the present gas barrier is very low. It can be applied using a simple lacquering method. Many businesses are already in possession of equipment for this purpose, since the lacquer layer can be applied using all standard lacquering techniques (gravure, slotted nozzle, spraying, squeegee application, dip coating, etc.).

The gas barrier can be produced with just a single lacquer layer of the suggested nanocomposite lacquer. But it can also be produced by a combination of multiple layers having different functions, for example by an alternating structure of layers of stretchable and soft polymer, and layers consisting of the proposed nanocomposite lacquer, that is to say also gas barrier layers according to the invention. The flexible layers are used to distribute force homogeneously when exposed to bending, stretching, compression or vibration.

In the production process for the nanocomposite lacquer, platelet-shaped nanoparticles are embedded in a polymer matrix. To do this, a suspension is made from water and platelet-shaped nanoparticles, which is mixed with a preferably water-soluble polymeric binder. The process is characterized in that the platelet-shaped nanoparticles are made of silicates, in particular phyllosilicates, which are comminuted with a dispersing mill, a rotation mill or a ball mill in such manner that the nanoparticles have at least a homogeneous size distribution such as is obtained in an exfoliation of montmorillonites as nanoparticles at a rotational speed of 400 rpm for more than 30 minutes in a ball mill (PULVERISETTE 6 from company Fritsch) operated with a zirconium dioxide container and zirconium dioxide balls having a ball diameter of less than 50 mm.

It is particularly advantageous for the gas barrier layer if montmorillonites are used as nanoparticles. In order for montmorillonites to serve as a platelet-shaped obstruction to diffusing molecules, the montmorillonite must first be separated or exfoliated to the nanoscale. This is done by mechanical comminution combined with intense mechanical shearing. In this process, it has been found that there are very large differences in the effectiveness of the gas barrier depending on how intensively the comminution in water is performed. Particular advantages are obtained when high shearing methods are implemented according to the proposed process, in particular through the use of dispersion mills, ball mills or rotation mills.

Use of a ball mill operated with zirconium dioxide containers and zirconium dioxide balls is particularly advantageous. This results in the formation of a particularly good gas barrier. In this case, the balls preferably have a diameter smaller than 50 mm, advantageously smaller than 20 mm, better smaller than 10 mm, particularly advantageously a diameter of 3 mm.

It has been found that when operating the ball mill a particularly advantageous setting for this process is a rotational speed between 250 and 500 rpm, particularly preferably a rotational speed of 400 rpm, and that the operation is continued for longer than 30 minutes, advantageously longer than 60 minutes, particularly advantageously 120 minutes or longer. But other settings relating to the material of the grinding container and the balls, the ball size, the rotational speed and the duration are conceivable, providing the homogeneous size distribution as stated is achieved.

Surprisingly, it has been found that despite the very large number of impacts with zirconium dioxide balls during the comminution the platelet structure of the montmorillonite is not destroyed, but remains intact. Instead, it was found that comminution with ball mill causes only existing aggregates and agglomerations to be broken up, and a particularly homogeneous size distribution of the particles is obtained. This is also true for the other mills used for mechanical shearing of the particles, and of other silicates, in the aqueous dispersion.

After dispersion in water, the nanoparticles have an aspect ratio of 10-500, an aspect ratio of 20 is particularly advantageous. The aspect ratio describes the ratio between the longest dimension or extension (longest extension perpendicular to the thickness direction) and the shortest dimension or extension (thickness of the platelets). In this case, the aspect ratio of 20 may be achieved for example with platelets or platelet-shaped nanoparticles having a thickness of 25 nm and a surface length of 500 μm. The thickness depends on how well the nanoparticles can be exfoliated, and may have a value from 1-2 nm (in the case of complete exfoliation to a single silicate platelet) up to 100 nm. In this context, the word “exfoliate” means the separation of the predominantly platelet-shaped nanoparticles from each other. Initially, the particles are arranged in a stack, wherein strong chemical, covalent bonds exist within the layers. The layers in themselves, that is to say one layer and the next layer, are held together by van-der-Waals forces. These van-der-Waals forces have to be overcome in order to separate the layers from each other and to obtain the single layers or platelets.

The more successful the exfoliation is, i.e. the separation of the individual silicate layers, the greater the barrier effect is. The aspect ratio of the particles is also crucial for determining the viscosity of the coating. The higher the aspect ratio is for the same solid fraction, the greater the viscosity of the nanoparticle dispersion and consequently the greater the viscosity after the dispersion is mixed with polymer. A higher aspect ratio also leads to prolongation of the permeation path (tortuosity) 4, as is represented schematically in FIG. 2, in which the platelet-shaped nanoparticles 1 are shown in the dried layer 2. In this context, tortuosity describes the prolongation of the permeation path 4 through the polymer matrix that is permeable for the permeating gas.

The production process of the nanocomposite lacquer and its optical appearance is particularly influential with regard to the properties of the gas barrier. The colour of the coating may be taken into account as a guide value for the barrier properties. The gas barrier produced with the proposed nanocomposite lacquer is particularly advantageous if the colour of the lacquer becomes whitish before it is applied to the surface. It has been found that gas barriers produced according to the invention are particularly high if the colour of the applied lacquer is snow-white, with L*-values higher than 80, advantageously higher than 85, particularly advantageously higher than 90.

In the production process for the nanocomposite lacquer, the nanoparticle dispersion and the corresponding suspension of water and nanoparticles are mixed with the polymer solution for introduction of the polymer matrix. It is advantageous if the polymer is introduced directly into the nanoparticle dispersion and dissolved. In a particularly advantageous embodiment, the binder is introduced directly into the nanoparticle dispersion, and is mixed with the suspension in the dispersion mill, rotation mill or ball mill. However, it may also be advantageous to dissolve the polymer first and then mix the polymer solution with the nanoparticle dispersion.

As described previously, the lacquer may be prepared with a solid content from 0.5 to 10% by mass, but it is preferably produced with a solid content from 3 to 8% by mass, better from 6 to 8% by mass.

Application using a squeegee, reverse gravure or slotted nozzle is ideal for a solid content of 6 to 8% by mass. With a solid content of less than 2% by mass, the viscosity is so low that application by means of spray coating is possible and advantageous.

Particularly effective barriers are obtained if the nanocomposite lacquer is applied to the substrate with a squeegee. In individual cases, however, a slotted nozzle, an printing process or spray coating may be used. The layer thickness of the dried lacquer may be from 0.2 μm to 1 mm; a layer thickness of the dried lacquer of 1 μm is particularly advantageous.

The gas barrier layer yields a very good gas barrier, the barrier is particularly effective with respect to oxygen, but also against hydrogen and helium. Thus, the gas barrier layer and the lacquer proposed for producing the gas barrier according to the invention are universally usable for gases with a gas-kinetic diameter of <0.35 nm. The layer and the lacquer can be used wherever an effective gas barrier in respect of small gases (hydrogen, helium, oxygen) is needed, including under high pressures. At the same time, the substrate may be a flexible component such as a film or hose, but also a rigid or curved component such as a pipe, or an expanding component, for example a tank. In this context, the gas barrier layer according to the invention offers particular advantages if the material of the component does not have an effective gas barrier itself, such as polymers or natural substances.

Metals, polymers, ceramics, natural substances (such as leather or wood, for example) and composites thereof all remain possible substrate materials.

In an advantageous embodiment of the invention, the application of the gas barrier layer to a film is combined with sealing of a solid component (a tank for example). For this purpose, first a flexible and expandable film is furnished with the gas barrier layer, and then the film is introduced into the container. The film may be attached adhesively to the surface of the container or affixed to the surface. The film may also just be place on the surface and then pressed against the container wall by the application of pressure in the interior of the container. With this method, the barrier may be created and dried outside the container, and the step of spraying the container from the inside can be avoided.

### BRIEF DESCRIPTION OF THE DRAWING

In the accompanying drawing:

FIG. 1 is a schematic representation of the alignment of the platelet-shaped nanoparticles after the application of the suggested nanocomposite lacquer for coating a substrate;

FIG. 2 is a schematic representation of the barrier effect due to lengthening of the permeation path through the nanoparticles present in the lacquer or the layer;

FIG. 3 shows an example of the various cut surfaces during a measurement of the suggested gas barrier layer compared with a gas barrier layer which has no such homogeneous distribution of the nanoparticles; and

FIG. 4 shows an example of the homogeneous size distribution of the nanoparticles in the lacquer according to the invention compared with a lacquer which has no such homogeneous distribution of the nanoparticles.

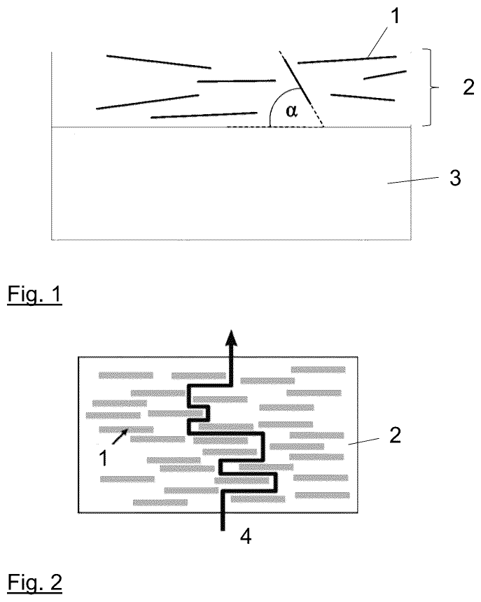

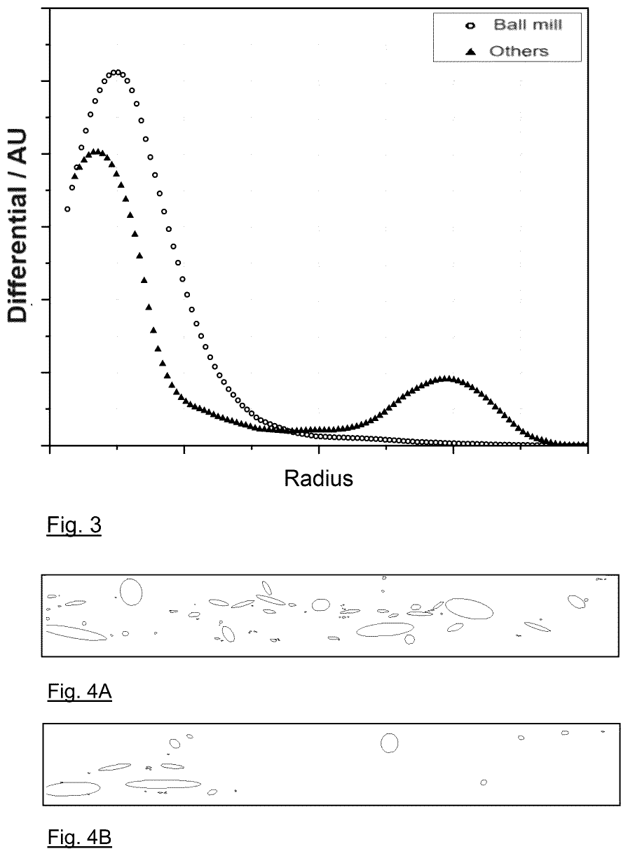

### WAYS TO IMPLEMENT THE INVENTION

In the following text, the production and application of the nanocomposite lacquer will be explained with reference to an example.

To begin, a 5% by mass dispersion of montmorillonite in water was produced in a planetary ball mill. 3 mm zirconium oxide balls were placed in a zirconium oxide container together with water and montmorillonite powder. The container was agitated in the ball mill for 2 h at 400 rpm. An opaque, whitish liquid was obtained.

This liquid was diluted with water until a solid content of 3% by mass was reached, and a further 3% by mass EVOH in the form of granulate was added to the liquid and dissolved for 1 h at 90° C.

The nanocomposite lacquer obtained thereby was spread on a polypropylene film (PP). A squeegee method with a wire squeegee was used as the application method, applying a liquid layer thickness of 33 μm. Then, the coated film was dried in a circulating oven for 2 min at 80° C. The determination of gas permeability was conducted according to DIN 53380-3 for oxygen.

The measurements for the table below were taken at 23° C. and 50% atmospheric humidity.

| | Layer | Permeation rate Q | Permeation coefficient P |
|---|---|---|---|
| | thickness d | cm³ (STP)/ | cm³ (STP) · 1 μm/ |
| Material | μm | (m2 · d · bar) | (m2 · d · bar) |
| PP | 30 | 1250 | 37500 |
| PVA | 1 μm | 1.4 | 1.4 |
| Nano- | 1 μm | 0.12 | 0.12 |
| composite | | | |

STP: Standard Temperature and Pressure

The permeation rates Qₜₒₜₐₗ obtained are the permeation rates of the coated film. In order to separate the permeation rate of the individual materials from each other, in this case the substrate and the coating, Q_{substrate} and Q_{coating}, the following formula is used.

$$\frac{1}{{Q}_{total}} = \frac{1}{{Q}_{substrate}} + \frac{1}{{Q}_{coating}}$$

To derive the permeation coefficient P from the permeation rate Q, the permeation rate is standardised for a layer thickness d, in this case for the layer thickness of 1 μm.

$$P = \frac{Q}{d}$$

The layer thickness describes the thickness of the dried lacquer respectively substrate.

The untreated PP film has an oxygen permeation coefficient of 37500 cm³·1 μm/(m²·d·bar). A PP film coated with untreated, 1 μm thick and dried EVOH has an oxygen permeation coefficient of von 1.4 cm³·1 μm/(m²·d·bar). A PP film, coated with the produced nanocomposite lacquer, has an oxygen permeation coefficient of 0.12 cm³·1 μm/(m²·d·bar) for a dry layer thickness of 1 μm.

1. A gas barrier layer consisting of a polymeric material, in which platelet-shaped nanoparticles are embedded, wherein the nanoparticles are silicates, in particular phyllosilicates,
characterized in that the nanoparticles in the polymeric material have a size distribution which is at least as homogeneous as that obtained in an exfoliation of montmorillonites as nanoparticles at a rotational speed of 400 rpm for more than 30 minutes in a ball mill operated with a zirconium dioxide container and zirconium dioxide balls having a ball diameter of less than 50 mm.

2. The gas barrier layer according to claim 1,
characterized in that
the nanoparticles are montmorillonites.

3. The gas barrier layer according to claim 1,
characterized in that
the gas barrier layer has a water fraction between 0.3-10% by mass.

4. The gas barrier layer according to claim 1, characterized in that the gas barrier layer has a permeation rate for helium less than 250 cm³·(STP) 1 μm/(m²·d·bar) per μm layer thickness.

5. The gas barrier layer according to claim 1, characterized in that the gas barrier layer has a permeation rate for oxygen from 0.05 to 0.2 cm³ (STP)·1 μm/(m²·d·bar) per μm layer thickness.

6. The gas barrier layer according to claim 1, characterized in that
the nanoparticles in the polymeric material have a homogeneous size distribution which is characterized in that in a micrograph of a cross-section of the gas barrier layer with a scanning electron microscope cut surfaces of silicate particles with a cut surface>0.01 μm² have an area fraction less than 10%, advantageously less than 5%, particularly advantageously less than 3% or 1%, of the total cut surface of the gas barrier layer.

7. The gas barrier layer according to claim 1, characterized in that
the gas barrier layer has a thickness between 0.2 and 1000 μm, preferably between 1 and 20 μm, particularly advantageously between 1 and 3 μm.

8. The gas barrier layer according to claim 1, characterized in that
the nanoparticles constitute a fraction amounting to 10 to 80% by mass, advantageously 25 to 60% by mass, particularly advantageously 50% by mass of the total solid content of the gas barrier layer.

9. A nanocomposite lacquer for producing the gas barrier layer according to claim 1,
which is formed by a mixture of a polymeric binder and platelet-shaped nanoparticles that have been dispersed in the binder,
wherein the nanoparticles are silicates, in particular phyllosilicates, which have a size distribution in the binder which is at least as homogeneous as that obtained by an exfoliation of montmorillonites as nanoparticles at a rotational speed of 400 rpm for more than 30 minutes in a ball mill, operated with a zirconium dioxide container and zirconium dioxide balls having an ball diameter of less than 50 mm.

10. The nanocomposite lacquer according to claim 9,
which has a brightness L*, determined according to CIE-L*a*b* colorimetry, of greater than 80, preferably greater than 85, particularly preferably greater than 90.

11. The nanocomposite lacquer according to claim 9, characterized in that
the binder is a polyvinyl alcohol with a fraction between 1 and 40% by mass ethylene, an acrylate, a polyurethane solution or a polyvinylidene chloride solution.

12. The nanocomposite lacquer according to claim 9, characterized in that the nanoparticles are montmorillonites.

13. The nanocomposite lacquer according to claim 9, characterized in that
the nanoparticles have a homogeneous size distribution in the binder which is characterized in that in a particle size distribution determined by laser diffraction a fraction of particles with an extension>1 μm in at least one dimension is less than 10%.

14. The nanocomposite lacquer according to claim 9, characterized in that
the nanoparticles have a thickness in the range from 10-30 nm and a surface length in the range from 150-500 nm.

15. The nanocomposite lacquer according to claim 9, characterized in that
the nanoparticles constitute a fraction of 10 to 80% by mass, advantageously 25 to 60% by mass, particularly advantageously 50% by mass of the total solid content of the lacquer.

16. The nanocomposite lacquer according to claim 9, characterized in that
the lacquer has a total solid content from 0.5 to 20% by mass, advantageously from 3 to 8% by mass, particularly advantageously of 6% by mass.

17. A process for producing the nanocomposite lacquer according to claim 9,
in which a suspension is produced from water and platelet-shaped nanoparticles and mixed with a polymeric binder,
wherein the platelet-shaped nanoparticles are formed from silicates, in particular phyllosilicates, which are comminuted in the suspension with a dispersing mill, a rotation mill or a ball mill in such manner that the nanoparticles have a size distribution which is at least as homogeneous as that obtained in an exfoliation of montmorillonites as nanoparticles at a rotational speed of 400 rpm for longer than 30 minutes in a ball mill operating with a zirconium dioxide container and zirconium dioxide balls having a ball diameter of less than 50 mm.

18. The process according to claim 17,
characterized in that
an aqueous solution of the binder is first produced and then mixed with the suspension.

19. The process according to claim 17,
characterized in that
the binder is introduced directly into the suspension and is dissolved there.

20. The process according to claim 17,
characterized in that
the binder is mixed with the suspension in the dispersing mill, rotation mill or ball mill.

21. The process according to claim 17, characterized in that
the comminution is carried out with a ball mill that is operated with zirconium dioxide containers and zirconium dioxide balls.

22. The process according to claim 17, characterized in that
the comminution is carried out with a ball mill, in which the balls have a diameter of less than 50 mm, advantageously less than 20 mm, better less than 10 mm, particularly advantageously a diameter of 3 mm.

23. The process according to claim 22,
characterized in that
the ball mill is operated with a rotational speed between 250 and 500 rpm, preferably of 400 rpm, for a period longer than 30 minutes, advantageously longer than 60 minutes, particularly advantageously for a period of 120 minutes.

24. The process according to claim 17, characterized in that
a polyvinyl alcohol with a fraction of ethylene, an acrylate, a polyurethane solution or
a polyvinylidene chloride solution between 1 and 40% is used as the binder.

25. The process according to claim 17, characterized in that
montmorillonites are used as the platelet-shaped nanoparticles.

26. The process according to claim 17, in which the nanocomposite lacquer is applied to and dried on a substrate in order to produce a gas barrier layer of a polymeric material, in which platelet-shaped nanoparticles are embedded, wherein the nanoparticles are silicates, in particular phyllosilicates,
characterized in that
the nanoparticles in the polymeric material have a size distribution which is at least as homogeneous as that obtained in an exfoliation of montmorillonites as nanoparticles at a rotational speed of 400 rpm for more than 30 minutes in a ball mill operated with a zirconium dioxide container and zirconium dioxide balls having a ball diameter of less than 50 mm.

27. The process according to claim 26,
characterized in that the lacquer is applied with a squeegee, a slotted nozzle, a printing process or spray coating.

28. The process according to claim 26,
characterized in that
the drying is carried out in such manner that the evaporation rate is between 5 and 100 g/m² per minute, advantageously between 10 and 50 g/m² per minute.
